(19) United States
(12) Patent Application Publication
(10) Pub. No.: US 2010/0209795 A1
(43) Pub. Date: Aug. 19, 2010

(54) POWER SUBSYSTEM FOR A FUEL CELL SYSTEM

(76) Inventors: Edward W. Hardwicke, Niskayuna, NY (US); James G. Hoehn, JR., Albany, NY (US)

Correspondence Address: TROP, PRUNER & HU, P.C., 1616 S. VOSS ROAD, SUITE 750, HOUSTON, TX, 77057-2631, US

(21) Appl. No.: 10/000,771

(22) Filed: Oct. 31, 2001

(51) Int. Cl. H01M 8/04

(52) U.S. Cl. 429/432

(57) ABSTRACT

A fuel cell system includes a fuel cell stack, a battery system, a power communication line and a power conditioning circuit. The fuel cell stack provides a stack voltage that stays near or below a first maximum voltage. The battery system includes a terminal that is coupled to the power communication line. The power conditioning circuit, in response to the stack voltage, provides a second voltage to the power bus. The second voltage stays near or below a second maximum voltage, and the second maximum voltage is greater than the first maximum voltage.

### BACKGROUND

The invention generally relates to a power subsystem for a fuel cell system.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:

H₂→2H⁺+2e⁻ at the anode of the cell, and

O₂+4H⁺+4e⁻→2H₂O at the cathode of the cell.

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

A battery may be used in a fuel cell system to supplement power that is provided by the fuel cell stack. In this manner, during times of increased power demand by the fuel cell system's load, the battery may discharge to contribute additional power to the fuel cell system's load to supplement the power produced by the fuel cell stack, and during non-peak times of power demand, the battery may be charged with power produced by the fuel cell stack. This charging and discharging of the battery may be complicated by the ever-changing terminal voltage of the fuel cell stack.

Thus, there exists a continuing need for an arrangement to control the charging and discharging of such a battery in a fuel cell system.

### SUMMARY

In an embodiment of the invention, a fuel cell system includes a fuel cell stack, a battery system, a power communication line and a power conditioning circuit. The fuel cell stack provides a stack voltage that stays near or below a first maximum voltage. The battery system includes a terminal that is coupled to the power communication line. The power conditioning circuit, in response to the stack voltage, provides a second voltage to the power communication line. The second voltage stays near or below a second maximum voltage, and the second maximum voltage is greater than the first maximum voltage.

Advantages and other features of the invention will become apparent from the following drawing, description and claims.

### BRIEF DESCRIPTION OF THE DRAWING

FIGS. 1 and 4 are schematic diagrams of fuel cell systems according to different embodiments of the invention.

FIG. 2 depicts waveforms of signals of the fuel cell system of FIG. 1 or 4 according to an embodiment of the invention.

FIG. 3 depicts waveforms of signals of another fuel cell system design.

### DETAILED DESCRIPTION

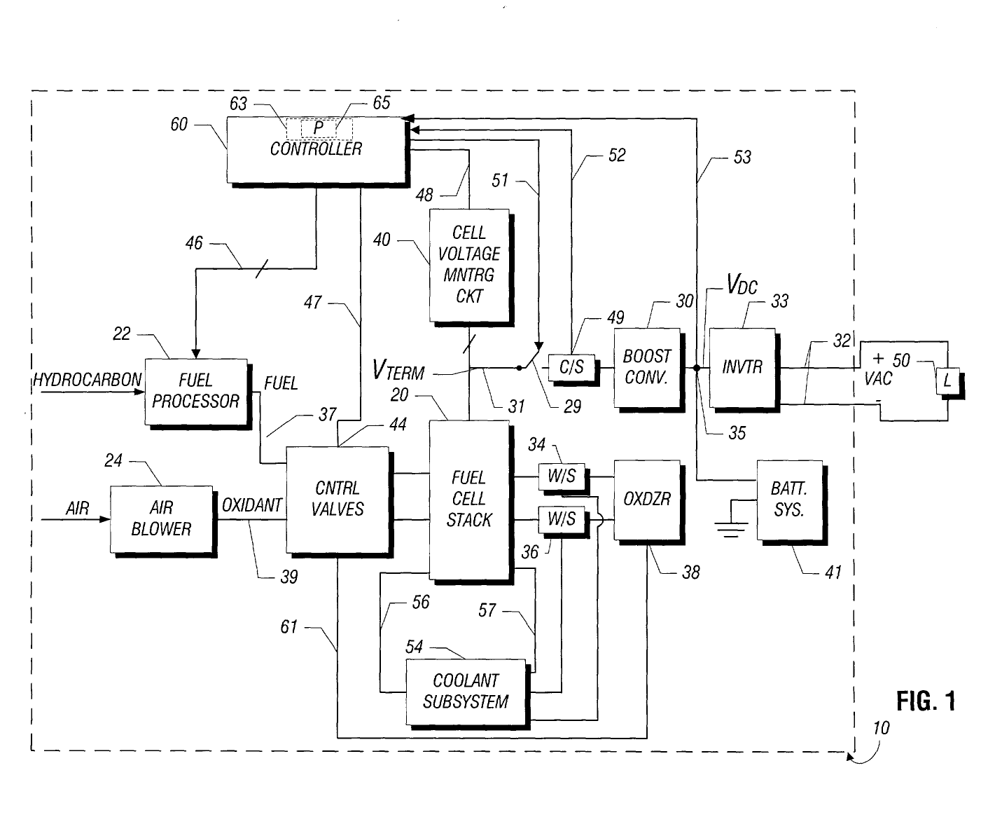

Referring to FIG. 1, an embodiment 10 of a fuel cell system in accordance with the invention includes a fuel cell stack 20 (a PEM-type fuel cell stack, for example) that is capable of producing power in response to fuel and oxygen flows that are provided by a fuel processor 22 and an air blower 24, respectively. In this manner, a controller 60 of the fuel processor 22, in response to monitored conditions in the fuel cell system 10, controls the level of fuel available for electrochemical reactions inside the fuel cell stack 20. This rate of fuel flow to the fuel cell stack 20, in turn, controls the level of power that is produced by the stack 20. The power that is produced by the fuel cell stack 20 is consumed primarily by an external load 50 (an external load such as a residential or commercial load and/or devices that are coupled to a power grid, as examples) and is also consumed by electrical components of the system 10.

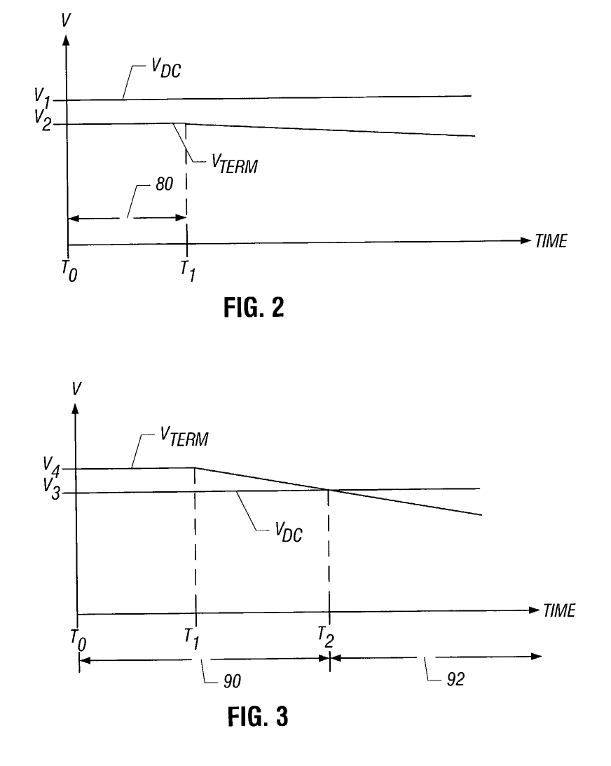

More particularly, the fuel cell stack 20 produces a terminal voltage, or stack voltage, (called V_{TERM}) at its output terminal 31. The V_{TERM} voltage may gradually decay over time, as depicted by a waveform of the V_{TERM} voltage in FIG. 2. In this manner, referring also to FIG. 2, from a time interval 80 from time T₀ to time T₁ (a time interval that represents a significant portion of the fuel cell stack's lifetime) the V_{TERM} stack voltage remains relatively constant. However, it is possible that the degradation of various cells of the fuel cell stack 20 may cause the V_{TERM} voltage to eventually decline, as depicted beginning at time T₁ in FIG. 2. The fuel cell system 10 accommodates this decline by including a converter 30 (see FIG. 1), a voltage conversion circuit that produces a regulated voltage (called V_{DC}) in response to the V_{TERM} voltage. In this manner, the converter 30 provides the V_{DC} voltage to a power communication line 35 that is coupled to a terminal of a battery system 41, and as a result, the V_{DC} voltage serves as the terminal voltage of the battery system 41. As described below, the converter 30 introduces a gain greater than one to “boost” the V_{TERM} terminal stack voltage for purposes of generating the V_{DC} voltage.

Due to the battery system's connection to the output terminal of the converter 30, the battery system 41 is charged (if needed) as long as the power that is demanded from the fuel cell stack 20 can be accommodated by the amount of fuel immediately available to the fuel cell stack 20 (i.e., as long as there is enough fuel to maintain a stable V_{TERM}).

The power that is demanded by load the 50 may vary over time, as the load 50 may represent a collection of individual loads (appliances and/or electrical devices that are associated with a house, for example) that may each be turned on and off at various times. As a result, the power that is consumed by the load 50 may rapidly change to produce a transient in power that is demanded from the fuel cell stack 20. This transient may be a significant change in power that deviates from the current steady state level of power present at the time the transient occurs, and the transient may have a time constant that is on the same order or less than the time constant of the fuel processor 22.

Therefore, the fuel processor 22 may not respond quickly enough to increase or decrease its fuel output to respond to a particular transient. As a result, the V_{TERM} voltage (i.e., the terminal voltage of the fuel cell stack 20) may significantly decrease during a rapid increase in power demand, as the fuel processor 22 may respond relatively slowly to the increased demand, and this slow response, in turn, may “starve” cells of the stack 20 for fuel, causing their voltages to decrease. This decrease in the V_{TERM} voltage may cause the converter 30 to be unable to maintain regulation of the V_{DC} voltage if not for the battery system 41. In this manner, for purposes of temporarily meeting the increased power demand until the fuel processor 22 increases its output to the appropriate level, the banks of the battery system 41 stabilize the V_{DC} voltage (and output AC voltage (called V_{AC})) and provide power to supplement the power that is produced by the fuel cell stack 20.

For times when the load 50 is not demanding such a relatively large power, the V_{TERM} voltage is at a sufficient level to cause the converter 30 to regulate the V_{DC} voltage to a sufficient level for purposes of charging the battery banks of the battery system 41 (if needed) via the power that is provided by the fuel cell stack 20. In some embodiments, the controller 60 may monitor cell voltages within the stack 20, and may remove the load from the stack 20 as necessary to prevent a cell voltage from getting low enough to cause damage to the cell. As an example, the controller 60 can effectively remove the load from the stack 20 by adjusting V_{DC} to be less than the voltage of the power communication line 35. As a further example, in some such embodiments, a diode arrangement may be used to prevent current from sinking to the stack where V_{DC} is less than the voltage of the power communication line 35.

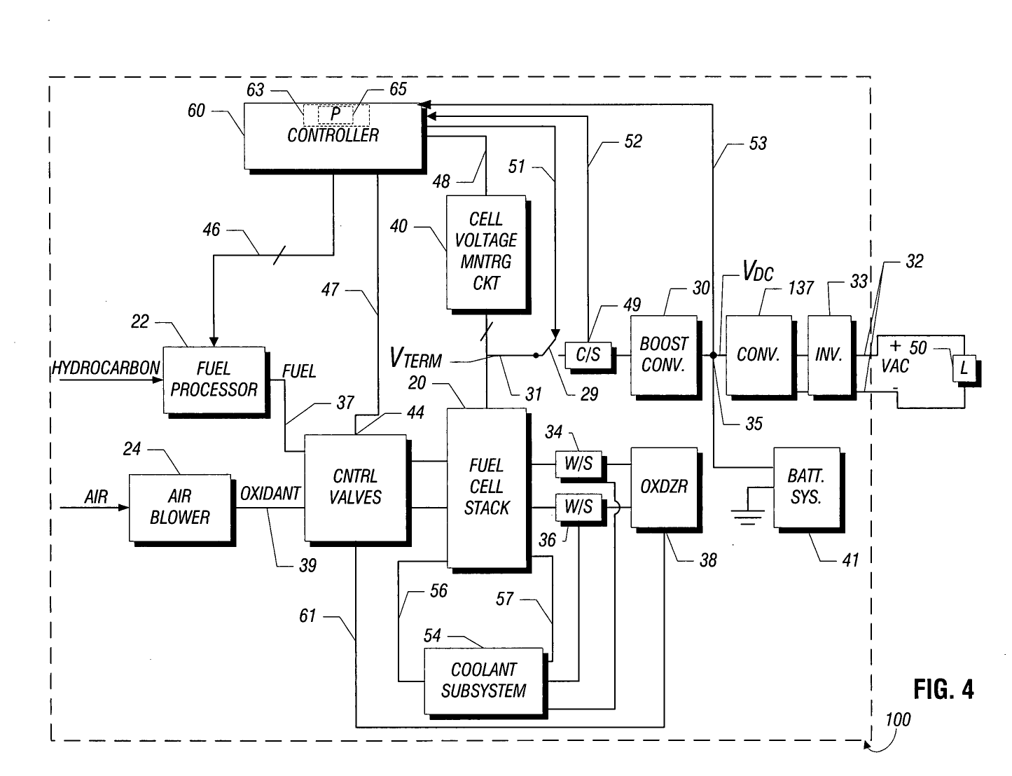

The following discussion assumes steady state operation of the fuel cell system 10 in the absence of power transients. Referring to both FIGS. 1 and 3, it is possible that in a given fuel cell system (not the fuel cell system 10, as contrasted below) the V_{TERM} voltage may have a maximum voltage (called V₄), the steady state stack voltage present when the fuel cell stack is relatively new. Thus, during the period from time T₀ to time T₁ when the fuel stack is relatively new, the V_{TERM} voltage may remain relatively constant. However, due to the degradation of the fuel cell stack of this given system over time, the V_{TERM} voltage may decrease, such as the decrease that begins near time T₁ in FIG. 3. This may present problems, depending on the choice of the maximum terminal voltage of the battery system that is coupled to the fuel cell stack.

For example, as illustrated in FIG. 3, in this given fuel cell system, the maximum voltage (called V₃) of the battery system is chosen below the V₄ maximum voltage of the stack. Therefore, in a time interval 90 from time T₀ to time T₂, the V_{TERM} stack voltage is greater than the V_{DC} voltage, a relationship that requires a converter of the system to introduce a gain to the V_{TERM} voltage for purposes of regulating the V_{DC} voltage at the proper level.

However, a problem may occur with the above described given system, as depicted in FIG. 3. In this manner, at time T₂, V_{TERM} stack voltage drops below the V_{DC} voltage to begin an interval 92 in which the V_{TERM} stack voltage thereafter remains below the V_{DC} voltage. As a result, the converter between the stack and battery must now have a gain less than one, thereby causing a change in the operation of the converter from introducing a gain more than one to introducing a gain less than one. Unfortunately, such a design for the converter may introduce a significant associated complexity and cost to the converter, as the converter must be able to handle gains above and below unity.

In contrast to the relationship between the battery and stack voltages that are described in the given system above, for the system 10, the V_{TERM} and V_{DC} voltages are chosen differently, as illustrated in FIG. 2. In this manner, referring to FIGS. 1 and 2, in the present invention, the maximum voltage (called V₁) of the V_{DC} battery voltage is chosen higher than the maximum voltage (called V₂) of the V_{TERM} stack voltage. For example, the maximum voltage of the V_{DC} voltage may be approximately ninety-six volts, and the maximum voltage of the V_{TERM} voltage may be approximately ninety volts. Other maximum voltages may be used in different embodiments of the invention.

Due to this relationship, the V_{DC} battery voltage remains above the V_{TERM} stack voltage, regardless of the degree of degradation of the stack 20. As a result, the converter 30 always introduces a gain greater than one to the V_{TERM} voltage to produce the V_{DC} voltage. Therefore, because the converter 30 always has a gain greater than one, the design of the converter 30 may be greatly simplified, as compared to a converter that must have a gain above and below unity for purposes of accommodating a change in the stack voltage.

As an example, in some embodiments of the invention, the converter 30 is preferably a Boost converter with a gain greater than one. As an example, such arrangements may be selected under the invention to reduce the size, weight, complexity, and parasitic losses associated with the system. However, in other embodiments, other types of converter topologies may also be used, such as flyback, Buck, and other switching converters.

It is noted that while it is possible to choose the maximum voltage level of the battery system 41 far below the maximum stack voltage to ensure that the V_{TERM} voltage is always above the V_{DC} voltage, this relationship may not be desirable as the battery system 41 would always be sinking current and charging to some extent. Thus, such an arrangement may be very inefficient in a system whose power efficiency may be a primary design concern.

Referring to FIG. 1, among the other features of the fuel cell system 10, the fuel cell system 10 may include a cell voltage monitoring circuit 40 that scans cell voltages of the fuel cell stack 20 and provides indications (via a serial bus 48, for example) to the controller 60. In this manner, the controller 60 may control operation of the fuel processor (via control lines 46) via the monitored cell voltages, as well as monitor stack current via a current indication is provided by a current sensor 49 that is coupled in series with the output terminal 31 of the fuel stack 20. The controller 60 may include, for example, a memory 63 (a read only memory (ROM), for example) that stores a program 65 that, when executed by the controller 60, causes the controller 60 to perform the functions described herein.

For purposes of powering the load 50, the fuel cell system 10 includes an inverter 33, a component that generates an AC voltage (on output terminals 32) in response to the V_{DC} voltage. Thus, in some embodiments of the invention, the input terminal of the inverter 33 is coupled to the output terminal of the converter 30.

The fuel cell system 10 also includes control valves that may be controlled by the controller 60 to divert some of the fuel flow that is otherwise received by the fuel cell stack 20 to an oxidizer 38 via a flow line 35. The oxidizer 38 may also burn off excess fuel that is not consumed in fuel cell reactions. The control valves 44 may also provide emergency shut off of the oxygen and fuel flows to the fuel cell stack 20. The control valves 44 are coupled between inlet fuel 37 and oxidant 39 lines and the fuel and oxidant manifold inlets, respectively, of the fuel cell stack 20. The inlet fuel line 37 receives a fuel flow from the fuel processor 22, and the inlet oxidant line 39 receives an oxidant flow from the air blower 24. The fuel processor 22 may receive, for example, a hydrocarbon (natural gas or propane, as examples) and convert this hydrocarbon into a fuel flow (a hydrogen flow, for example) that is provided to the inlet fuel line 37.

The fuel cell system 10 may also include water separators, such as water separators 34 and 36, to recover water from the outlet and/or inlet fuel and oxidant ports of the fuel cell stack 20. The water that is collected by the water separators 34 and 36 may be routed to a water tank (not shown) of a coolant subsystem 54 of the fuel cell system. The coolant subsystem 54 circulates (via inlet 56 and outlet 57 coolant lines) a coolant, such as de-ionized water, for example, through the fuel cell stack 20 to regulate the operating temperature of the stack 20.

Other arrangements are possible. For example, referring to FIG. 4, in some embodiments of the invention, the fuel cell system 10 may be replaced by a fuel cell system 100. The fuel cell system 100 has a similar design to the fuel cell system 10, with the following differences. In particular, in the fuel cell system 100, the V_{DC} battery voltage is not provided directly to the inverter 33. Instead, the fuel cell system 100 includes an additional converter 37 (a Boost, flyback or Buck converter, as just a few examples) to further regulate the V_{DC} voltage to produce another regulated voltage (having a different voltage level) that is provided to the inverter 33. As an example, the V_{DC} battery voltage may be sized (e.g., 96 volts) such that the stack voltage of an 88 cell low temperature PEM stack will always be less than the V_{DC} battery voltage. Other configurations and topologies are possible.

Finally, it will be appreciated that while the above discussion has illustrated the invention with respect to fuel cell systems utilizing fuel processors for fuel delivery, the invention also applies to pure hydrogen systems. For example, the invention may also apply to fuel cell systems using pure hydrogen, including those that are “dead-headed” such that the anode chambers of the fuel cell are exposed to pressurized hydrogen and periodically vented to remove inert materials accumulated in the anode chambers. Such systems may also have fuel delivery response constraints analogous to the lag time issues with hydrogen delivery from fuel processor systems.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A fuel cell system comprising:
a power communication line;
a fuel cell stack to provide a stack voltage that stays near or below a maximum voltage;
a battery system including a terminal that is connected to the power communication line;
a first voltage converter to, in response to the stack voltage, provide a first regulated DC voltage to the power communication line, the first DC regulated voltage being greater than the maximum voltage; and
a second voltage converter to receive the first regulated DC voltage from the power communication line and convert the first regulated DC voltage into a second regulated DC voltage different from the first regulated DC voltage.

2. (canceled)

3. The fuel cell system of claim 1, wherein the first voltage converter has a gain greater than one.

4. The fuel cell system of claim 1, wherein the first voltage converter comprises a Boost converter.

5. (canceled)

6. The fuel cell system of claim 1, further comprising:
an inverter to generate an AC voltage in response to the second regulated voltage.

7. The fuel cell system of claim 1, wherein a difference between the stack voltage and the maximum voltage increases over time.

8. The fuel cell system of claim 1, wherein the maximum voltage is approximately ninety volts.

9. The fuel cell system of claim 1, wherein the first voltage converter regulates the first regulated DC voltage near ninety-six volts.

10. The fuel cell system of claim 1, further comprising:
an inverter to convert the second regulated voltage into an AC voltage.

11. A method comprising:
operating a fuel cell stack to provide a stack voltage that stays near or below a maximum voltage;
connecting a terminal of a battery system to a power communication line;
converting the stack voltage into a first regulated DC voltage;
providing the first regulated DC voltage to the power communication line, the first regulated DC voltage being greater than the maximum voltage; and
converting the first regulated DC voltage into a second regulated DC voltage different from the first regulated DC voltage.

12. The method of claim 11, wherein the converting the stack voltage comprises boosting the stack voltage.

13. The method of claim 12, wherein the converting the stack voltage further comprises communicating the stack voltage to a Boost converter.

14. The method of claim 11, wherein the stack voltage decreases below the maximum voltage over time.

15. The method of claim 11, wherein the maximum voltage is approximately ninety volts.

16. The method of claim 11, wherein the converting the stack voltage comprises regulating the first regulated voltage near ninety-six volts.

17. The fuel cell system of claim 1, wherein the first voltage converter regulates the first regulated DC voltage in response to a feedback of the first regulated DC voltage.

18. The fuel cell system of claim 1, wherein the second voltage converter regulates the second regulated DC voltage in response to feedback of the second regulated DC voltage.

19. The method of claim 11, wherein the act of providing the first regulated DC voltage comprises providing feedback of the first regulated DC voltage.

20. The method of claim 11, wherein the act of converting the first regulated DC voltage into the second regulated DC voltage comprises providing feedback of the second regulated DC voltage.
